(19) United States
(12) Patent Application Publication
(10) Pub. No.: US 2017/0156536 A1
(43) Pub. Date: Jun. 8, 2017

(54) CONTAINER DEVICE FOR COOKING FOOD

(71) Applicant: ZUKSEOK SSALBAB CO., LTD., Anseong-si (KR)

(72) Inventors: Seok-Tae GONG, Anseong-si (KR); Seon-Yeong GONG, Anseong-si (KR)

(21) Appl. No.: 15/327,030

(22) PCT Filed: Mar. 13, 2015
(86) PCT No.: PCT/KR2015/002482

§ 371 Date: Jan. 17, 2017

(30) Foreign Application Priority Data
Jul. 22, 2014 (KR) 10-2014-0092379
Jul. 25, 2014 (KR) 10-2014-0094439
Jul. 29, 2014 (KR) 10-2014-0096843
Jul. 30, 2014 (KR) 10-2014-0096952
Jul. 31, 2014 (KR) 10-2014-0097957
Aug. 5, 2014 (KR) 10-2014-0100269
Aug. 28, 2014 (KR) 10-2014-0112954
Mar. 10, 2015 (KR) 10-2015-0033016

(51) Int. Cl. A47J 27/04; B65D 51/16; B65D 17/00; B65D 81/34

(52) U.S. Cl. CPC A47J 27/04; B65D 81/3438; B65D 81/3484; B65D 51/16; B65D 17/163; A47J 2027/043

(57) ABSTRACT

The container device for cooking food is disclosed, the device comprising: a housing having an inner space defined therein, and a top cover, wherein non-cooked rice is received in the inner space, wherein the top cover is openable; a first hole defined in the top cover; an elastic steam filter disposed on an inner face of the cover to block the first hole, wherein the elastic steam filter is flexible and wherein the elastic steam filter is configured to allow passage of steam and to disallow passage of water, wherein the elastic steam filter includes nano-fibers; a support attached on the inner face of the cover to support the elastic steam filter; and a second hole defined in the support to vertically overlap the first hole.

### BACKGROUND

Field of the Present Disclosure

The present disclosure relates to a container device for cooking food. More particularly, the present disclosure relates to a container device for cooking food wherein the food is cooked simply without a microwave oven or a separate hot water.

Discussion of Related Art

Modern society is transforming our social environment and lifestyle, especially dietary pattern, with high economic growth and rapid change of living standard. Modern people have pursued simplicity in their complex lives. As a result of the economic growth, the quality of life is gradually increasing, so that the food industry is prospering and the use of instant convenience food is increasing rapidly. In addition, the convenience food market is growing every year as the leisure life such as camping is increased due to 5-day work per a week.

Among these ready-to-eat foods, precooked dried rice can be eaten warm by using a microwave oven or the like. The precooked dried rice has a merit of being able to eat hot rice on the spot only by simple cooking about 3 minutes or less.

FIG. 1 is a view illustrating a conventional instant food container in which precooked dried rice is packaged. Referring to FIG. 1, the conventional instant food container 10 includes a main body 12 having a space formed therein and a top thereof opened, and a cover film 14 covering the opened top of the main body 12. Then, the rice is processed to prepare precooked dried rice (not shown). Then, precooked dried rice is received in the inside of the body 12, and then the cover film 14 seals the body 12.

Such a conventional instant food container must use a separate electronic device such as a microwave oven or have a separate hot water, so that there is a serious restriction on cooking.

On the other hand, since precooked dried rice is cooked by processing rice, it is classified as a commodity and the value added tax is taxed. However, since rice itself is an agricultural product and the value added tax is exempted. Thus, if a product where a certain amount of raw rice is packaged and is directly cooked is introduced, it will be able to receive the VAT exemption benefit and lower the product price.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter.

The present disclosure is to provide a container device for cooking food wherein the food is cooked simply without a microwave oven or a separate hot water.

In one aspect, a container device for cooking food, the device comprises a housing having an inner space defined therein, and a top cover, wherein non-cooked rice is received in the inner space, wherein the top cover is openable; first and second holes defined in the top cover in first and second positions respectively; an elastic blocking rubber disposed on an inner face of the cover to block the first hole, wherein the rubber is flexible; a first support attached on the inner face of the cover to support the blocking rubber; a steam filter disposed on an inner face of the cover to block the second hole, wherein the steam filter is configured to allow passage of steam and to disallow passage of water, wherein the steam filter is made of nano-fibers; a second support attached on the inner face of the cover to support the steam filter; a third hole defined in the first support to vertically overlap the first hole; a fourth hole defined in the second support to vertically overlap the second hole.

In one implementation, the first support is configured such that when a downward-pressure is applied to the blocking rubber, one end of the blocking rubber is removed from the first support and is bent downwards through the third hole into the inner space while the other end of the blocking rubber is supported by the first support.

In one implementation, the device further comprises a fifth hole defined in the top cover in a third position; a further steam filter disposed on an inner face of the cover to block the fifth hole, wherein the further steam filter is configured to allow passage of steam and to disallow passage of water, wherein the steam filter is made of nano-fibers; a third support attached on the inner face of the cover to support the further steam filter; and a sixth hole defined in the third support to vertically overlap the fifth hole.

In another aspect, a container device for cooking food, the device comprises a housing having an inner space defined therein, and a top cover, wherein non-cooked rice is received in the inner space, wherein the top cover is openable; a first hole defined in the top cover; an elastic steam filter disposed on an inner face of the cover to block the first hole, wherein the elastic steam filter is flexible and wherein the elastic steam filter is configured to allow passage of steam and to disallow passage of water, wherein the elastic steam filter includes nano-fibers; a support attached on the inner face of the cover to support the elastic steam filter; and a second hole defined in the support to vertically overlap the first hole.

In one implementation, the support is configured such that when a downward-pressure is applied to the steam filter, one end of the steam filter is removed from the support and is bent downwards through the second hole into the inner space while the other end of the steam filter is supported by the support.

In one implementation, the device further comprises a solid fuel based heater disposed on or under a bottom of the housing.

In accordance with the present disclosure, the food is cooked simply without a microwave oven or a separate hot water. The present container device have an application for outdoor activities, such as camping.

Further, in accordance with the present disclosure, the container device having a raw rice received therein is for sales and, hence, it will be able to receive the VAT exemption benefit and lower the product price.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 is a view illustrating a conventional instant food container in which precooked dried rice is packaged.

FIG. 2 is a perspective view of a casing of a container device for cooking food in accordance with a preferred first embodiment of the present disclosure.

FIG. 3 is a perspective view of a combination of a casing and a cover of a container device for cooking food in accordance with a preferred first embodiment of the present disclosure.

FIG. 4 is a cross-sectional view for describing a first blocker and a second blocker of the container device for cooking food in accordance with a preferred first embodiment of the present disclosure.

FIG. 5 is a cross-sectional view for describing feeding of water through the first blocker into the container device for cooking food in accordance with a preferred first embodiment of the present disclosure.

FIG. 6 is a cross-sectional view for describing one example of cooking food in the container device for cooking food in accordance with a preferred first embodiment of the present disclosure.

FIG. 7 is a cross-sectional view for describing another example of cooking food in the container device for cooking food in accordance with a preferred first embodiment of the present disclosure.

FIG. 8 is a cross-sectional view of a container device for cooking food in accordance with a preferred second embodiment of the present disclosure.

FIG. 9 is a cross-sectional view for describing feeding of water through a first blocker into the container device for cooking food in accordance with a preferred second embodiment of the present disclosure.

FIG. 10 is a cross-sectional view for describing one example of cooking food in the container device for cooking food in accordance with a preferred second embodiment of the present disclosure.

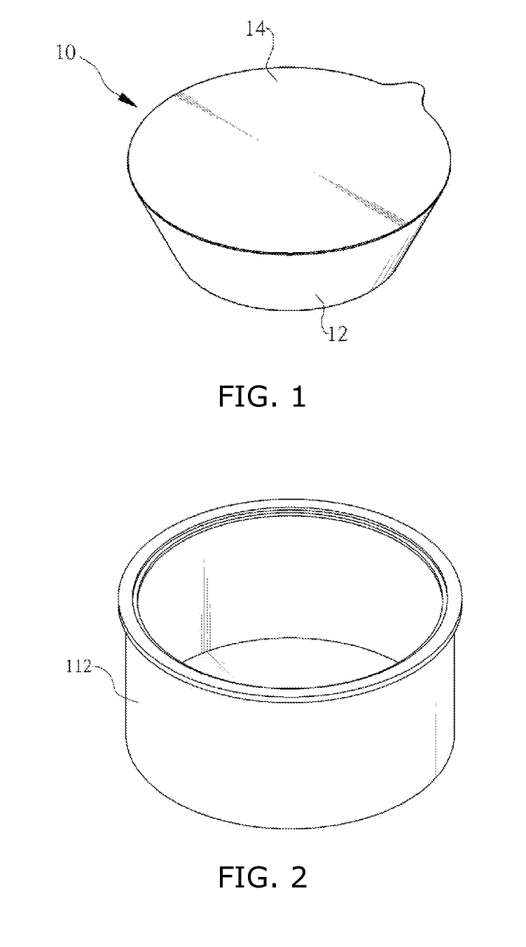

Reference numerals

| | |
|---|---|
| 100: container device | 110: container body |
| 112: casing | 114: cover |
| 114a: first hole | 144b: second hole |
| 115: grip | 115a: grip hole |
| 120: first blocker | 121: first support |
| 122: first through-hole | 123: blocking rubber |
| 125: second blocker | 126: second support |
| 127: second through-hole | 128: steam filter |
| 129: blocking and filtering member | 130: solid fuel |
| 140: burner | 200: water injector |
| 210: cylinder | 220: piston |
| 230: needle | |

For simplicity and clarity of illustration, elements in the figures are not necessarily drawn to scale. The same reference numbers in different figures denote the same or similar elements, and as such perform similar functionality. Also, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

### DETAILED DESCRIPTIONS

Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

Spatially relative terms, such as “beneath,” “below,” “lower,” “under,” “above,” “upper,” and the like, may be used herein for ease of explanation to describe one element or feature's relationship to another element s or feature s as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented for example, rotated 90 degrees or at other orientations, and the spatially relative descriptors used herein should be interpreted accordingly.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items. Expression such as “at least one of” when preceding a list of elements may modify the entire list of elements and may not modify the individual elements of the list.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description, numerous specific details are set forth in order to provide a thorough understanding of the present disclosure. The present disclosure may be practiced without some or all of these specific details. In other instances, well-known process structures and/or processes have not been described in detail in order not to unnecessarily obscure the present disclosure.

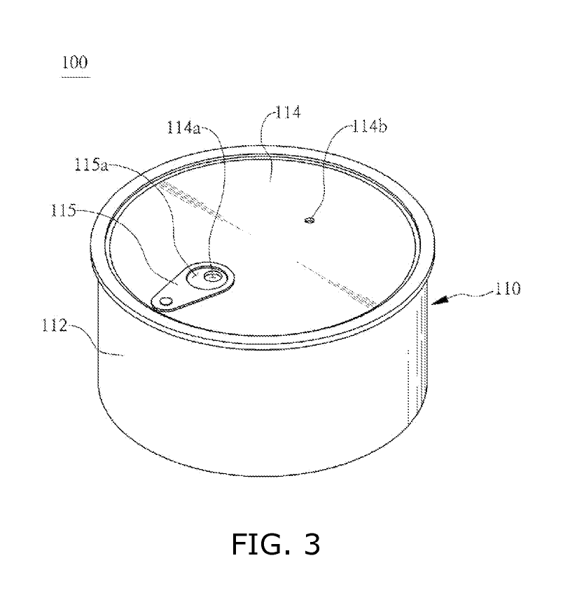

FIG. 2 is a perspective view of a casing of a container device for cooking food in accordance with a preferred first embodiment of the present disclosure. FIG. 3 is a perspective view of a combination of a casing and a cover of a container device for cooking food in accordance with a preferred first embodiment of the present disclosure.

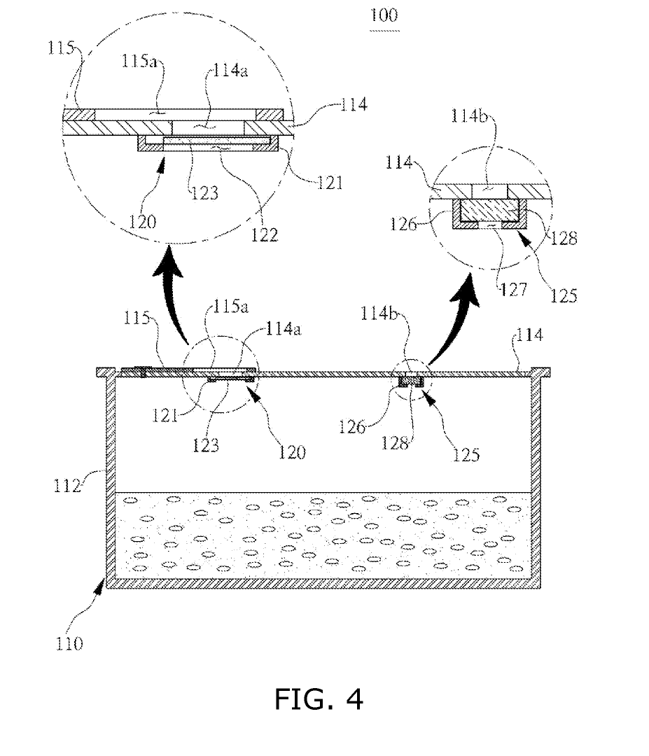

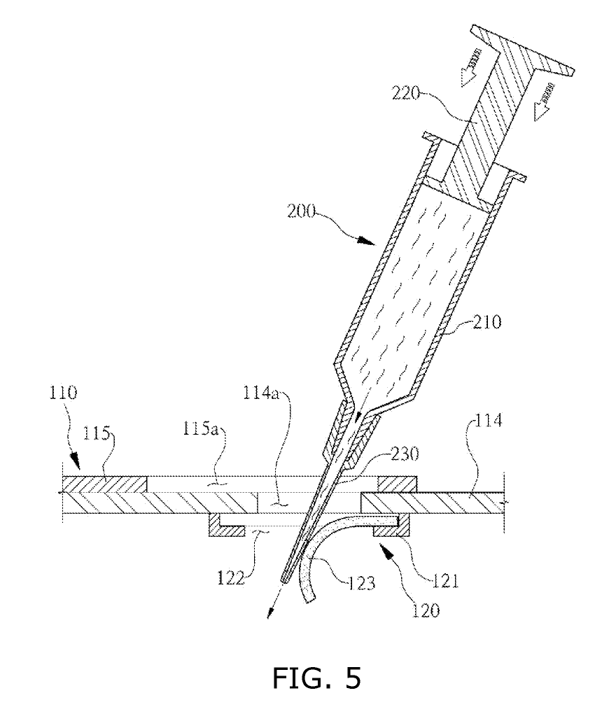

Referring to FIG. 2 and FIG. 3, a container device 100 for cooking food in accordance with a preferred first embodiment of the present disclosure may include a container body 110, a first blocker 120 (FIG. 4) and a second blocker 125 (FIG. 4).

The container body 110 may store therein food such as non-cooked rice. The container body 110 may be made of a metal material that is solid and easy to transmit heat. The container body 110 includes a casing 112 having an inner space formed therein to receive non-cooked rice or the like and an opened top portion, and a cover 114 for opening and closing the top portion of the casing 112. A first hole 114a is formed in the cover 114 in a first position and a second hole 114b is formed in the cover 114 in a second position. The cover 114 is configured to open the casing 112. For example, the cover 114 is provided with a grip 115 on its outer face, and a cut line is formed along the outer periphery of the cover 114. The cover 114 is attached to the casing 112 so that the casing 112 can be easily opened in a one-touch manner by griping the grip 115 and pulling up the grip 115 and allowing the cover 114 to be removed from the top portion of the casing 112 along the cut line. Thus, this may dispense with any additional tool for opening the casing 112. On the other hand, a grip hole 115a defined in the grip 115 can be positioned to overlap the first hole 114a.

The first blocker 120 and second blocker 125 will be described in details below.

FIG. 4 is a cross-sectional view for describing a first blocker and a second blocker of the container device for cooking food in accordance with a preferred first embodiment of the present disclosure.

Referring to FIG. 4, the first blocker 120 is configured to open and close the first hole 114 a of the cover 114. The first blocker 120 includes a blocking rubber 123 to block the first hole 114a. The blocking rubber 123 of the elastic material is disposed on an inner face of the cover 114 so as to block the first hole 114a. The blocking rubber 123 is supported by a first support 121 coupled thereto. The first support 121 is constituted by a fixing tape or the like attached to the inner face of the cover 114. The first support 121 has separated first and second portions. The first portion extends over a portion of a lower surface of the blocking rubber 123. The first portion is coupled to the inner face of the cover 114. However, the second portion does not extend over a portion of a lower surface of the blocking rubber 123. In other words, as shown in FIG. 4, the first portion supports the left side portion of the blocking rubber 123 and fixes the left side portion of the blocking rubber 123 to the cover 114, while the second portions does not extend over a portion of a lower surface of the blocking rubber 12 but contacts the blocking rubber 12 in an edge-to-edge manner. That is, an upper right edge of the first portion contacts a lower left edge of the blocking rubber 12. Thus, the first hole 114 a does not air-communicate with an inner space in the casing 112 due to the blocking rubber 12. A first through-hole 122 is formed at the center of the first support 121. This is, the first through-hole 122 is formed between the first portion and second portion. The first through-hole 122 overlaps the first hole 114a. The first through-hole 122 is blocked from the first hole 114a via the blocking rubber 123. Thus, the left side portion of the blocking rubber 123 is movable. The left side portion of the blocking rubber 123 is not fixed by the first support 121. The left side portion of the blocking rubber 123 moves the first through-hole 122 and is bent in a direction away from the first hole 114a. As shown in FIG. 5, when a water injector 200 presses down the blocking rubber 123 and, thus, the blocking rubber 123 is bent such that the water injector 200 passes through the first hole 114a and the first through-hole 122. Thus, water can be easily injected into the container body 110 through the water injector 200.

The second blocker 125 closes the second hole 114b. The second blocker 125 includes a nano-fiber-made steam filter 128 which is disposed on the inner face of the cover 114 to block the second hole 114b of the cover 114. The nano-fiber-made steam filter 128 is coupled to the inner face of the cover 114. The nano-fiber-made steam filter 128 is supported by a second support 126. The steam filter 128 is embodied by a well-known technique widely used for outdoor products having a moisture permeability function. The steam filter 128 is configured to allow passage of steam and disallow passage of liquid water through the filter. Under the container body 110, solid fuel 130 may be disposed. When the container body 110 is heated using the solid fuel 130 or the like, steam is generated in the container body 110, and, then, the steam is discharged to the outside through the steam filter 128. By closing the second hole 114b using the steam filter 128, the rice received in the casing 112 of the container body 110 is cooked without the cover 114 being opened while the internal pressure therein is constant. Further, there is no risk of explosion of the main body of the container 100 due to the expansion of the internal air therein because the steam generated from the heated water passes through the steam filter 128 to the outside of the main body 110. In addition, since bacteria or dust outside the container body 110 cannot pass through the steam filter 128, the inside of the container body 110 is not contaminated. The second support 126 is for securing the steam filter 128 firmly to the inner face of the cover 114, and is constituted by, for example, a fixing tape or the like. A second through hole 127 is formed in the second support 126. The second through hole 127 overlaps the second hole 114b. Thus, the water vapor inside the container body 110 can be discharged through the second through-hole 127 and then the steam filter 128 and then the second hole 114b to the outside of the container body 110. The second through-hole 127 may be formed in plural and the second hole 114b may be formed in plural. The plurality of the second through-holes 127 position-correspond to the plurality of the second holes 114b respectively. When the second through-hole 127 and the second hole 114b are formed in plural, the water vapor inside the container body 110 can be discharged to the outside more quickly.

Further, a first tape type film blocker (not shown) is attached on the outer side of the cover 114 to block the first hole 114a. A second tape type film blocker (not shown) is attached on the outer side of the cover 114 to block the second hole 114b. In this way, external air does not flow into the container body 110 through the first hole 114a and the second hole 114b. When the rice in the container body 110 is to be cooked, the first and second tape type film blockers may be detached from the cover 114.

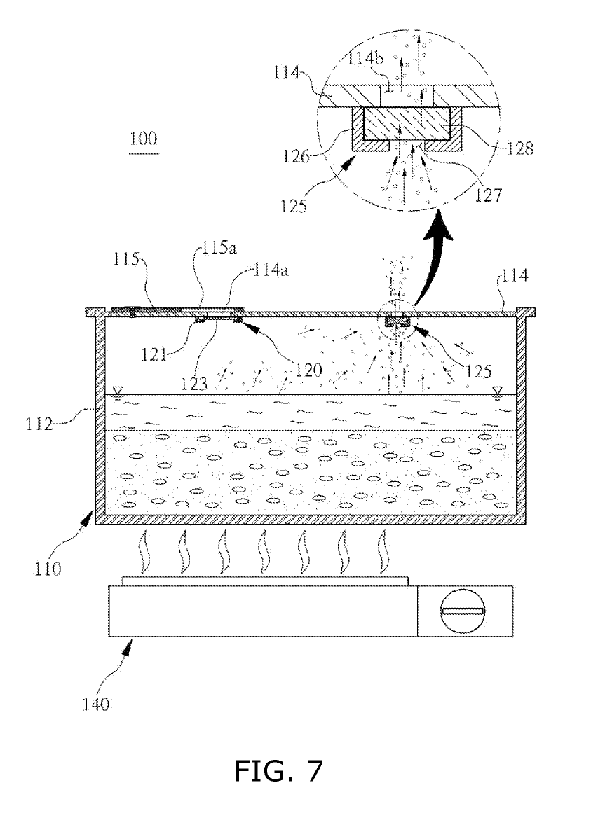

Hereinafter, a process for cooking food such as non-cooked rice in the container device for cooking food in accordance with a preferred first embodiment of the present disclosure will be described in details with reference to FIG. 5 to FIG. FIG. 7.

FIG. 5 is a cross-sectional view for describing feeding of water through the first blocker into the container device for cooking food in accordance with a preferred first embodiment of the present disclosure.

Referring to FIG. 5, non-cooked rice is contained in the container body 110, and water is injected into the container body 110 using the water injector 200. The water injector 200 is composed of a syringe or the like and includes a cylinder 210 for receiving water, a piston 220 movably mounted in the cylinder 210 to pressurize the water contained in the cylinder 210. A needle 230 is disposed on one end of the cylinder 210.

When the needle 230 is inserted into the grip hole 115a and then the first hole 114a, and then the blocking rubber 123 is pressed down, the blocking rubber 123 is bent to open the first hole 114a. In this connection, the piston 220 is pressurized so that water in the cylinder 210 is injected into the container body 110. In this connection, the rice contained in the container body 110 amounts to, for example, 120 g, and the water injected into the container body 110 amounts to, for example, 150 cc.

When the water injection is completed, the needle 230 is removed from the first hole 114a. In this connection, the blocking rubber 123 is returned to its original position due to its own elasticity to close the first hole 114a.

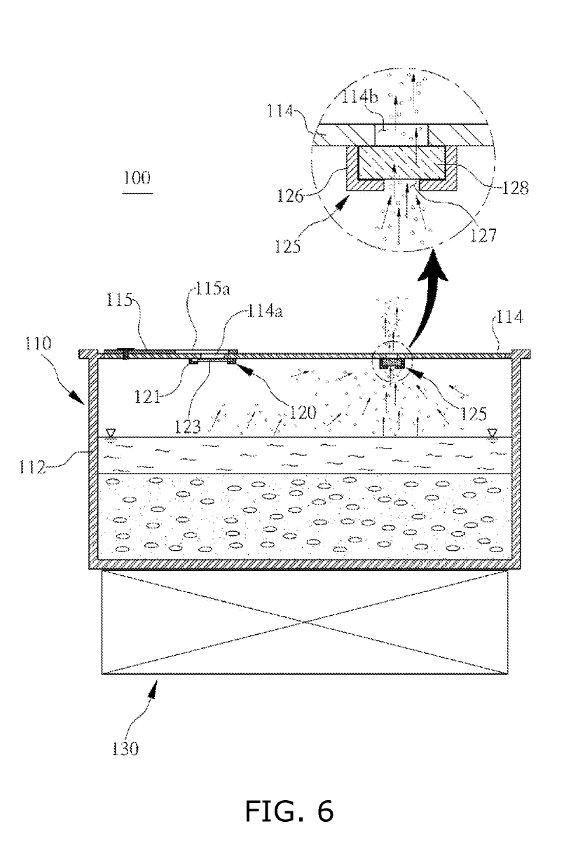

FIG. 6 is a cross-sectional view for describing one example of cooking food in the container device for cooking food in accordance with a preferred first embodiment of the present disclosure.

Referring to FIG. 6, a solid fuel 130 is provided under the container body 110. The solid fuel 130 directly heats the container body 110 so that the water injected into the container body 110 is boiled to cook the rice. These solid fuels 130 include, for example, a first solid fuel (not shown) and a second solid fuel (not shown) smaller than the first solid fuel, wherein the first solid fuel is located above the second solid fuel. The container body 110 is placed on the first solid fuel. Then, when the first solid fuel is ignited, combustion starts from the first solid fuel. Then, when the combustion of the first solid fuel is finished, the second solid fuel starts to burn. In this connection, the first solid fuel is strong in a thermal power because of its large size, while the second solid fuel is weak in a thermal power because of its small size. Accordingly, first, the first solid fuel starts boiling the water injected into the container body 110 using the strong thermal power, and, then, after a certain period of time, the second solid fuel begins to burn. Since the second solid fuel is weak in the thermal power, the rice is uniformly well done.

Meanwhile, when the water inside the container body 110 starts to be boiled by the solid fuel 130, the inside of the container body 110 is filled with steam, which passes through the second through-hole 127 and then the steam filter 128 and then the second hole 114b and then is discharged out of the body 110.

Thus, using the cooking container in accordance with the present disclosure, the food such as non-cooked rice can be cooked easily without preparing a microwave oven or a separate hot water. This cooking container in accordance with the present disclosure may have applications for outdoor activities such as camping.

In addition, the present disclosure has the effect of lowering the price of the product as the present container device because raw or non-cooked rice is contained in the container body 110, thereby obtaining the VAT exemption benefit.

FIG. 7 is a cross-sectional view for describing another example of cooking food in the container device for cooking food in accordance with a preferred first embodiment of the present disclosure.

Referring to FIG. 7, instead of the solid fuel 130 as shown in FIG. 6, a burner 140 may be employed. The burner 140 is generally used in camping and the like, and the container body 110 can be heated using a gas in the gas container installed in the burner 140.

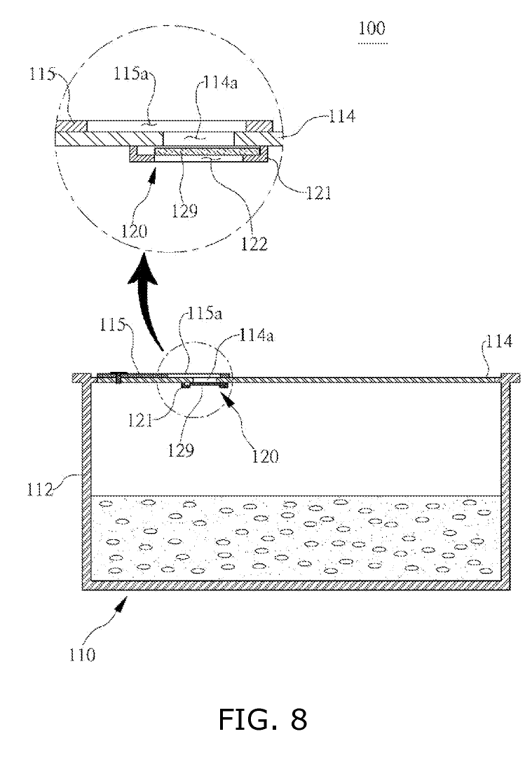

FIG. 8 is a cross-sectional view of a container device for cooking food in accordance with a preferred second embodiment of the present disclosure.

Referring to FIG. 8, the container device for cooking food in accordance with a preferred second embodiment of the present disclosure is identical with the container device for cooking food in accordance with the preferred second embodiment of the present disclosure except that the blocking rubber 123 of the first blocker 120 in the first embodiment is changed to a blocking and filtering member 129, and the second blocker 125 in the first embodiment is absent.

Referring to FIG. 8, a container device 100 for cooking food in accordance with a preferred second embodiment of the present disclosure may include a container body 110, and a first blocker 120.

The container body 110 may store therein food such as non-cooked rice. The container body 110 may be made of a metal material that is solid and easy to transmit heat. The container body 110 includes a casing 112 having an inner space formed therein to receive non-cooked rice or the like and an opened top portion, and a cover 114 for opening and closing the top portion of the casing 112. A first hole 114a is formed in the cover 114 in a first position and a second hole 114b is formed in the cover 114 in a second position. The cover 114 is configured to open the casing 112. For example, the cover 114 is provided with a grip 115 on its outer face, and a cut line is formed along the outer periphery of the cover 114. The cover 114 is attached to the casing 112 so that the casing 112 can be easily opened in a one-touch manner by griping the grip 115 and pulling up the grip 115 and allowing the cover 114 to be removed from the top portion of the casing 112 along the cut line. Thus, this may dispense with any additional tool for opening the casing 112. On the other hand, a grip hole 115a defined in the grip 115 can be positioned to overlap the first hole 114a. The first blocker 120 will be described in details below.

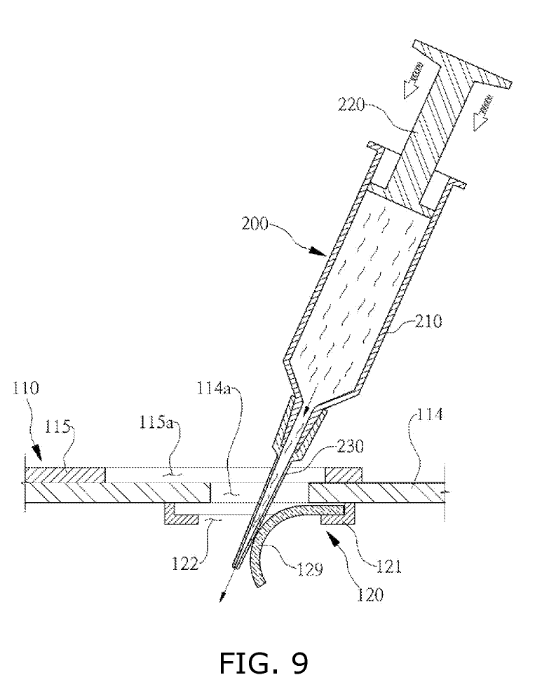

Referring to FIG. 8, the first blocker 120 is configured to open and close the first hole 114a of the cover 114. The first blocker 120 includes a blocking and filtering member 129 to block the first hole 114a. The blocking and filtering member 129 is made of the elastic and nano-fiber material. Thus, the blocking and filtering member 129 functions as both the blocking rubber 123 and the steam filter 128 in the first embodiment. The blocking and filtering member 129 is disposed on an inner face of the cover 114 so as to block the first hole 114a. The blocking and filtering member 129 is supported by a first support 121 coupled thereto. The first support 121 is constituted by a fixing tape or the like attached to the inner face of the cover 114. The first support 121 has separated first and second portions. The first portion extends over at least a portion of a lower surface of the blocking and filtering member 129. The first portion is coupled to the inner face of the cover 114. However, the second portion does not extend over a portion of a lower surface of the blocking and filtering member 129. In other words, as shown in FIG. 8, the first portion supports the left side portion of the blocking and filtering member 129 and fixes the left side portion of the blocking and filtering member 129 to the cover 114, while the second portions does not extend over a portion of a lower surface of the blocking and filtering member 12 but contacts the blocking and filtering member 12 in an edge-to-edge manner. That is, an upper right edge of the first portion contacts a lower left edge of the blocking and filtering member 12. Thus, the first hole 114a does not air-communicate with an inner space in the casing 112 due to the blocking and filtering member 12. A first through-hole 122 is formed at the center of the first support 121. This is, the first through-hole 122 is formed between the first portion and second portion. The first through-hole 122 overlaps the first hole 114a. The first through-hole 122 is blocked from the first hole 114a via the blocking and filtering member 129. Thus, the left side portion of the blocking and filtering member 129 is movable. The left side portion of the blocking and filtering member 129 is not fixed by the first support 121. The left side portion of the blocking and filtering member 129 moves the first through-hole 122 and is bent in a direction away from the first hole 114a. As shown in FIG. 9, when a water injector 200 presses down the blocking and filtering member 129 and, thus, the blocking and filtering member 129 is bent such that the water injector 200 passes through the first hole 114a and the first through-hole 122. Thus, water can be easily injected into the container body 110 through the water injector 200.

The blocking and filtering member 129 is configured to allow passage of steam and disallow passage of liquid water through the filter. Under the container body 110, solid fuel 130 may be disposed. When the container body 110 is heated using the solid fuel 130 or the like, steam is generated in the container body 110, and, then, the steam is discharged to the outside through the blocking and filtering member 129. By closing the first hole 114a using the blocking and filtering member 129, the rice received in the casing 112 of the container body 110 is cooked without the cover 114 being opened while the internal pressure therein is constant. Further, there is no risk of explosion of the main body of the container 100 due to the expansion of the internal air therein because the steam generated from the heated water passes through the blocking and filtering member 129 to the outside of the main body 110. In addition, since bacteria or dust outside the container body 110 cannot pass through the blocking and filtering member 129, the inside of the container body 110 is not contaminated.

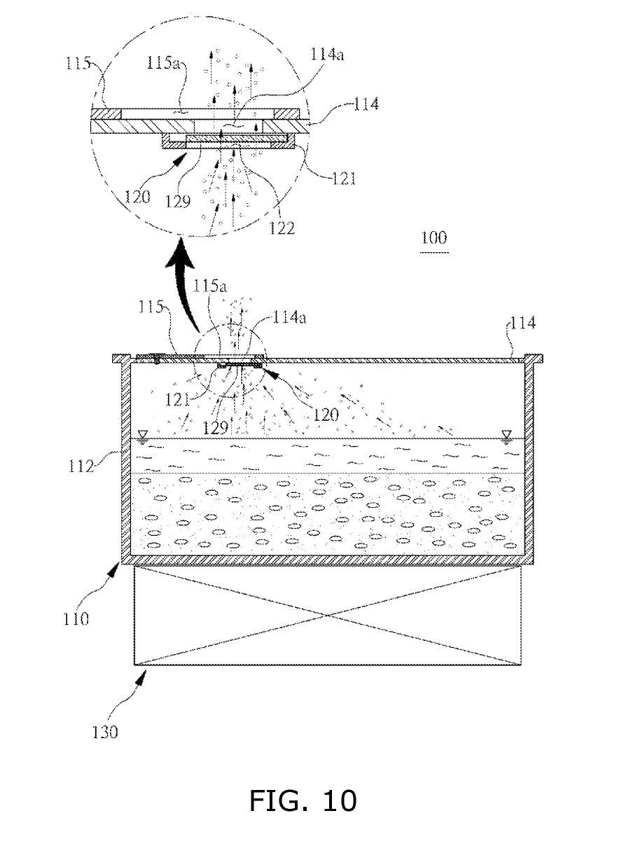

Hereinafter, a process for cooking food such as non-cooked rice in the container device for cooking food in accordance with a preferred second embodiment of the present disclosure will be described in details with reference to FIG. 9 to FIG. FIG. 10.

FIG. 9 is a cross-sectional view for describing feeding of water through the first blocker into the container device for cooking food in accordance with a preferred second embodiment of the present disclosure.

Referring to FIG. 9, non-cooked rice is contained in the container body 110, and water is injected into the container body 110 using the water injector 200. The water injector 200 is composed of a syringe or the like and includes a cylinder 210 for receiving water, a piston 220 movably mounted in the cylinder 210 to pressurize the water contained in the cylinder 210. A needle 230 is disposed on one end of the cylinder 210.

When the needle 230 is inserted into the grip hole 115a and then the first hole 114a, and then the blocking and filtering member 129 is pressed down, the blocking and filtering member 129 like the blocking rubber 123 in the first embodiment is bent to open the first hole 114a. In this connection, the piston 220 is pressurized so that water in the cylinder 210 is injected into the container body 110. In this connection, the rice contained in the container body 110 amounts to, for example, 120 g, and the water injected into the container body 110 amounts to, for example, 150 cc.

When the water injection is completed, the needle 230 is removed from the first hole 114a. In this connection, the blocking and filtering member 129 like the blocking rubber 123 in the first embodiment is returned to its original position due to its own elasticity to close the first hole 114a.

FIG. 10 is a cross-sectional view for describing one example of cooking food in the container device for cooking food in accordance with a preferred second embodiment of the present disclosure.

Referring to FIG. 10, a solid fuel 130 is provided under the container body 110. The solid fuel 130 directly heats the container body 110 so that the water injected into the container body 110 is boiled to cook the rice. These solid fuels 130 include, for example, a first solid fuel (not shown) and a second solid fuel (not shown) smaller than the first solid fuel, wherein the first solid fuel is located above the second solid fuel. The container body 110 is placed on the first solid fuel. Then, when the first solid fuel is ignited, combustion starts from the first solid fuel. Then, when the combustion of the first solid fuel is finished, the second solid fuel starts to burn. In this connection, the first solid fuel is strong in a thermal power because of its large size, while the second solid fuel is weak in a thermal power because of its small size. Accordingly, first, the first solid fuel starts boiling the water injected into the container body 110 using the strong thermal power, and, then, after a certain period of time, the second solid fuel begins to burn. Since the second solid fuel is weak in the thermal power, the rice is uniformly well done.

Meanwhile, when the water inside the container body 110 starts to be boiled by the solid fuel 130, the inside of the container body 110 is filled with steam, which passes through the first through-hole 122 and then the blocking and filtering member 129 and then the first hole 114a and then is discharged out of the body 110.

Thus, using the cooking container in accordance with the present disclosure, the food such as non-cooked rice can be cooked easily without preparing a microwave oven or a separate hot water. This cooking container in accordance with the present disclosure may have applications for outdoor activities such as camping.

In addition, the present disclosure has the effect of lowering the price of the product as the present container device because raw or non-cooked rice is contained in the container body 110, thereby obtaining the VAT exemption benefit.

The above description is not to be taken in a limiting sense, but is made merely for the purpose of describing the general principles of exemplary embodiments, and many additional embodiments of this disclosure are possible. It is understood that no limitation of the scope of the disclosure is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

1. A container device for cooking food, the device comprising:
a housing having an inner space defined therein, and a top cover, wherein non-cooked rice is received in the inner space, wherein the top cover is openable;
first and second holes defined in the top cover in first and second positions respectively;
an elastic blocking rubber disposed on an inner face of the cover to block the first hole, wherein the rubber is flexible;
a first support attached on the inner face of the cover to support the blocking rubber;
a steam filter disposed on an inner face of the cover to block the second hole, wherein the steam filter is configured to allow passage of steam and to disallow passage of water, wherein the steam filter is made of nano-fibers;
a second support attached on the inner face of the cover to support the steam filter;
a third hole defined in the first support to vertically overlap the first hole;
a fourth hole defined in the second support to vertically overlap the second hole.

2. A container device for cooking food, the device comprising:
a housing having an inner space defined therein, and a top cover, wherein non-cooked rice is received in the inner space, wherein the top cover is openable;
a first hole defined in the top cover;
an elastic steam filter disposed on an inner face of the cover to block the first hole, wherein the elastic steam filter is flexible and wherein the elastic steam filter is configured to allow passage of steam and to disallow passage of water, wherein the elastic steam filter includes nano-fibers;
a support attached on the inner face of the cover to support the elastic steam filter; and
a second hole defined in the support to vertically overlap the first hole.

3. The device of claim 1, wherein the first support is configured such that when a downward-pressure is applied to the blocking rubber, one end of the blocking rubber is removed from the first support and is bent downwards through the third hole into the inner space while the other end of the blocking rubber is supported by the first support.

4. The device of claim 2, wherein the support is configured such that when a downward-pressure is applied to the steam filter, one end of the steam filter is removed from the support and is bent downwards through the second hole into the inner space while the other end of the steam filter is supported by the support.

5. The device of claim 1, wherein the fourth hole is plural.

6. The device of claim 1, further comprising a solid fuel based heater disposed on or under a bottom of the housing.

7. The device of claim 2, further comprising a solid fuel based heater disposed on or under a bottom of the housing.
